(19) United States
(12) Patent Application Publication
(10) Pub. No.: US 2006/0294591 A1
(43) Pub. Date: Dec. 28, 2006

(54) Virus enabled application metering in distributed and on-demand computing environments

(75) Inventors: Michael George Polan, Markham (CA); Hari Haranath Madduri, Austin, TX (US)

Correspondence Address: Steven M. Greenberg, Esq.;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/169,039

(22) Filed: Jun. 28, 2005

(51) Int. Cl. G06F 12/14; H04L 9/32; G06F 11/00; G06F 11/30; G06F 12/16; G06F 15/18; G08B 23/00

(52) U.S. Cl. 726/24; 713/188

(57) ABSTRACT

There is provided a method, system and apparatus for viral based application metering. In a method of the invention, an application can be infected with viral logic programmed to transmit application metrics to a central meter over a data communications network. For instance, the infecting step can include infecting an application with viral logic programmed to transmit periodic heartbeats to a central meter over a data communications network. Also, the infecting step can include infecting an application with viral logic programmed to report a starting of the application to a central meter over a data communications network.

### BACKGROUND OF THE INVENTION

1. Statement of the Technical Field

The present invention relates to the field of distributed and on-demand computing, and more particularly to application metering in a distributed and on-demand computing environment.

2. Description of the Related Art

Among the many challenges faced by those who manage the capacity and performance of an enterprise system is the characterization of resource consumption by a particular application or workload. The continuing movement towards distributed systems has complicated this activity as there are several methods for collecting transaction data on a single system: For instance, a transaction processing monitor can be configured to capture some form of resource consumption data. Similarly, some database management systems provide facilities for capturing transaction activity within the context of each access request.

Facilities within a particular operating system also may have a built-in notion of what a transaction is and will store or report information related to that transaction. Furthermore, applications developers can imbed instrumentation within application code in order to obtain transaction specific data. Finally, application profilers for a particular operating environment can gather large amounts of data relating to the behavior of an application hosted within the operating environment. In all cases, however, when applied to the distributed environment, it can be difficult to track resource consumption by a transaction when several elements in a network contribute towards the completion of a transaction

In an on demand computing environment, the role of a host computing device and the workload processed in the host can vary based upon business need, the point-in-time when the workload is processed, the volume of different workloads experienced at that time, and the relative priorities of those workloads. A change in demand for specific applications can result in the re-provisioning of a host computing device that had previously served requests for a particular workload, into a different role hosting different applications. Thus, application metering can be of the utmost importance in optimizing the performance of the on demand computing environment.

Yet, developing application metering techniques for the on demand environment can be a complicated process. Application metering end points, whether disposed in a client or server host platform, can require the deployment of agents and end point managers for all anticipated applications and systems. Additionally, application signature recognition logic must be developed for all anticipated applications and systems.

### SUMMARY OF THE INVENTION

Embodiments of the present invention address the deficiencies of the art in respect to application metering and provide a novel and non-obvious method, system and apparatus for viral based application metering. In a method of an embodiment of the invention, an application can be infected with viral logic programmed to transmit application metrics to a central meter over a data communications network. For instance, the infecting step can include infecting an application with viral logic programmed to transmit periodic heartbeats to a central meter over a data communications network. Also, the infecting step can include infecting an application with viral logic programmed to report a starting of the application to a central meter over a data communications network.

Notably, the infecting step can include infecting an application with viral logic programmed both to propagate the viral logic to other applications disposed in application hosts communicatively linked to an application host hosting the application, and to transmit application metrics to a central meter over a data communications network. Additionally, the infecting step can include infecting a multiplicity of applications across multiple application hosts in a distributed, on demand environment with viral logic programmed to transmit application metrics to a central meter over a data communications network. Likewise, the infecting step can include infecting a multiplicity of applications across multiple application hosts in a distributed, on demand environment with viral logic programmed to transmit periodic heartbeats to a central meter over a data communications network.

A viral based application metering system can include a central meter, and one or more applications operating in corresponding application hosts. Each of the applications can have a viral infection programmed to transmit application metrics to the central meter over a data communications network. In this regard, the application metrics can include periodic heartbeat messages. Additionally, the viral infectoin can be programmed to transmit compliance information to the central meter which compliance information can include an application identity and an associated user. Using the compliance information, it can be determined whether the use has engaged in the use of an application which has not been authorized for use by the user. Also, by compelling applications to reveal compliance information through the viral infection, the absence of a required application can be determined in contravention of an end user computing policy, for instance.

In one aspect of the invention, the application hosts can form an on demand environment. Also, anti-viral logic can be included in the system and can be configured to permit the viral infection. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of a distributed system configured for virus enabled application metering in accordance with an embodiment of the present invention; and,

FIG. 2 is a flow chart illustrating a process for virus enabled application metering for use in the system of FIG. 1.

### DETAILED DESCRIPTION OF THE PREFERRED EMBODIMENTS

Embodiments of the present invention provide a method, system and apparatus for virus enabled application metering. In accordance with an embodiment of the present invention, an application monitor can be distributed to subject applications in a distributed environment through viral propagation. Once installed in an application operating in an application host, the application monitor can provide metrics to a central meter in the distributed environment. Additionally, the application monitor can provide a heartbeat to the central meter so as to provide an indication to the central meter that the application monitor remains active in association with the monitored application. Finally, the application monitor can identify other applications in the application host which can be infected with the application monitor.

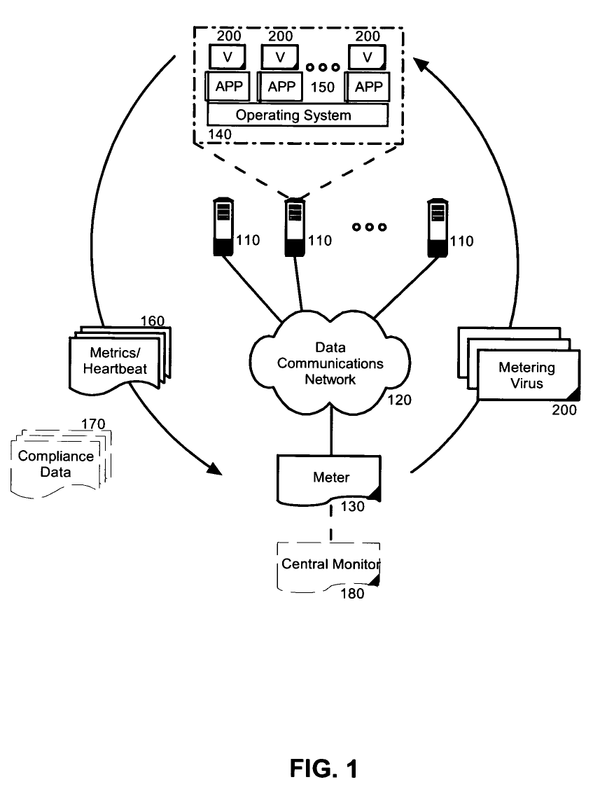

In further illustration, FIG. 1 is schematic illustration of a distributed system configured for virus enabled application metering. The distributed system can include one or more application hosts 110 disposed about a data communications network 120. Each of the application hosts 110 can include a host operating system 140 which can support the operation of one or more applications 150. Notably, the distributed system can be an on demand environment in which resources can be allocated and de-allocated on demand as required by clients of the on demand environment.

In accordance with the present invention, a central meter 130 can be communicatively linked to the application hosts 110 over the data communications network 120. The central meter 130 can be programmed to inject viral logic 200 into communicatively coupled application hosts 110. Once injected, the viral logic 200 can propagate to each application 150 operating in a corresponding one of the application hosts 110. When associated with an application 150, the viral logic 200 can provide metrics 160 to the central meter 130.

The metrics 160 can include, by way of example, the identity of the application host 110 and the application 150 along with a date stamp, time stamp and client process identifier. Additionally, the viral logic 200 can provide a heartbeat (also shown as part of the metrics 160) to the central meter 130 such that the central meter 130 can detect when the application 150 has terminated it operation within a corresponding application host 110. Importantly, to the extent that the application host 110 includes anti-viral logic (not shown), the anti-viral logic can be configured to permit the operation of the viral logic 200.

In addition to the metrics 160, the viral logic 200 can provide compliance data 170 to a central monitor 180. The compliance data 170 can include not only the identity of the application 150, but also the identity of the corresponding application host 110. The central monitor 180 can compare the collected identities with a table or policy indicating which applications are permitted for use in the application host 110, or those applications which are required for use in the application host 110. Thus, the viral logic 200 can assist in enforcing compliance with a computing policy for the distributed system.

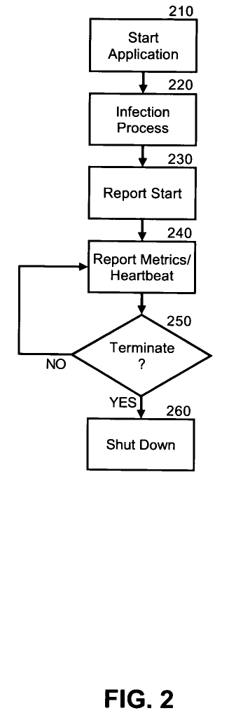

In further illustration of the operation of the viral logic 200, FIG. 2 is a flow chart illustrating a process for virus enabled application metering for use in the system of FIG. 1. Beginning in block 210, an infected application in an application host can start which can result in the viral logic engaging in an infection process in block 220 for other applications in the application host as well as engaging in an infection process for other application hosts communicatively accessible from the application host. Subsequently, in block 230 the viral logic can forward a message to the central meter indicating the start of the infected application.

In block 240, the viral logic can forward a message to the central meter indicating metric data, such as the identity of the client process accessing the infected application, the date and time of the message and the identity of the infected application and corresponding application host. Additionally, a heartbeat message can be provided to the central meter. Subsequently, in decision block 250 it can be determined whether or not to terminate the viral logic. If not the process can repeat through block 240. Otherwise, the viral logic can terminate in block 260.

In a particular aspect of the invention, the viral logic, once having infected an application, will allow no further infections that are identical or older than itself. Conversely, the viral logic, once having infected an application, will permit itself to be replaced with a newer version of the viral logic. As noted before, however, once having infected a computing host, the viral logic can identify the applications installed in the host and the viral logic can infect each identified application. Also, once the viral logic has infected a host platform, the viral logic can deliberately open an additional, known infection route to ease subsequent updates. Finally, to prevent unauthorized viral infections, the viral logic can self-require authentication with a central source prior to completing the infection process.

Embodiments of the present invention can be realized in hardware, software, or a combination of hardware and software. An implementation of the method and system of the present invention can be realized in a centralized fashion in one computer system, or in a distributed fashion where different elements are spread across a number of interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product embodied in a computer usable medium, which comprises all the features enabling the implementation of the methods described herein, and which, when loaded in a computer system is able to carry out these methods.

It is important to note that while embodiments of the present invention have been described in the context of a fully functioning data processing system, those of ordinary skill in the art will appreciate that the processes of embodiments of the present invention are capable of being distributed in the form of a computer usable medium of instructions and a variety of forms and that embodiments of the present invention apply equally regardless of the particular type of signal bearing media actually used to carry out the distribution. Examples of computer usable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer usable media may take the form of coded formats that are decoded for actual use in a particular data processing system.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

I claim:

1. A viral based application metering method comprising the step of:
infecting an application with viral logic programmed to transmit application metrics to a central meter over a data communications network.

2. The method of claim 1, wherein said infecting step comprises the step of infecting an application with viral logic programmed to transmit periodic heartbeats to a central meter over a data communications network.

3. The method of claim 1, wherein said infecting step comprises the step of infecting an application with viral logic programmed both to propagate said viral logic to other applications disposed in application hosts communicatively linked to an application host hosting said application, and to transmit application metrics to a central meter over a data communications network.

4. The method of claim 1, wherein said infecting step comprises the step of infecting an application with viral logic programmed to report a starting of said application to a central meter over a data communications network.

5. The method of claim 1, wherein said infecting step comprises the step of infecting a plurality of applications across multiple application hosts in a distributed, on demand environment with viral logic programmed to transmit application metrics to a central meter over a data communications network.

6. The method of claim 1, wherein said infecting step comprises the step of infecting a plurality of applications across multiple application hosts in a distributed, on demand environment with viral logic programmed to transmit periodic heartbeats to a central meter over a data communications network.

7. The method of claim 1, further comprising the steps of:
receiving compliance data from said viral logic; and,
monitoring compliance with a computing policy based upon said received compliance data.

8. A viral based application metering system comprising:
a central meter;
a plurality of applications operating in corresponding application hosts, each of said applications having a viral infection programmed to transmit application metrics to said central meter over a data communications network.

9. The system of claim 8, wherein said application hosts form an on demand environment.

10. The system of claim 8, wherein said application metrics comprise periodic heartbeat messages.

11. The system of claim 8, further comprising a compliance monitor configured to receiving compliance data from each said viral infection and to monitor compliance with a computing policy based upon said received compliance data.

12. The system of claim 8, further comprising anti-viral logic configured to permit said viral infection.

13. A machine usable medium having stored thereon a computer program for viral based application metering, the computer program comprising a routine set of instructions which when executed by the machine causes the machine to perform the step of infecting an application with viral logic programmed to transmit application metrics to a central meter over a data communications network.

14. The machine usable medium of claim 13, wherein said infecting step comprises the step of infecting an application with viral logic programmed to transmit periodic heartbeats to a central meter over a data communications network.

15. The machine usable medium of claim 13, wherein said infecting step comprises the step of infecting an application with viral logic programmed both to propagate said viral logic to other applications disposed in application hosts communicatively linked to an application host hosting said application, and to transmit application metrics to a central meter over a data communications network.

16. The machine usable medium of claim 13, wherein said infecting step comprises the step of infecting an application with viral logic programmed to report a starting of said application to a central meter over a data communications network.

17. The machine usable medium of claim 13, wherein said infecting step comprises the step of infecting a plurality of applications across multiple application hosts in a distributed, on demand environment with viral logic programmed to transmit application metrics to a central meter over a data communications network.

18. The machine usable medium of claim 13, wherein said infecting step comprises the step of infecting a plurality of applications across multiple application hosts in a distributed, on demand environment with viral logic programmed to transmit periodic heartbeats to a central meter over a data communications network.

19. The machine usable medium of claim 13, further comprising an additional set of instructions which when executed by the machine causes the machine to further perform the steps of:
receiving compliance data from said viral logic; and,
monitoring compliance with a computing policy based upon said received compliance data.
